(19) United States
(12) Patent Application Publication
(10) Pub. No.: US 2022/0134350 A1
(43) Pub. Date: May 5, 2022

(54) METHODS AND APPARATUS FOR REMOVING CONTAMINANTS FROM CONTAMINATED SOLIDS

(71) Applicant: SIGNET AGGREGATES, LLC, Casper, WY (US)

(72) Inventor: ROBERT DELANE BALDWIN, Casper, WY (US)

(21) Appl. No.: 17/087,937

(22) Filed: Nov. 3, 2020

(51) Int. Cl. B02C 23/30; B02C 23/26; B02C 23/06; B03B 1/04; B03B 5/00; B03B 11/00

(52) U.S. Cl. CPC B02C 23/30; B02C 23/26; B03B 11/00; B03B 1/04; B03B 5/00; B02C 23/06

(57) ABSTRACT

An apparatus and process mechanically remove hydrocarbons and other contaminants from solids through high energy slurry impact with a stationary plate or through high energy slurry impact of two or more slurry streams. In addition to the mechanical process, a gas additive, such as CO₂, in solid, liquid or gas form, can be introduced into the slurry stream. The presence of gas additive can aid in the liberation of the contaminant. The process can increase efficiencies, reduce costs and improve thoroughness of contaminate cleaning in conjunction with aqueous pressure and sheer energy.

### BACKGROUND OF THE INVENTION

### 1. Field of the Invention

Embodiments of the invention relate generally to methods and apparatus for removing contaminants from solids. More particularly, embodiments of the present invention relate to methods and apparatus removing hydrocarbons and other contaminants from contaminated solids.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Hydrocarbon and other chemical contamination of soils, drilling cuttings and other solids have been a concern and problem in various industries for decades.

Chemical, thermal, and mechanical methods currently considered state of the art and in widespread use globally for cleaning solid media from hydrocarbons and other chemical contaminants vary widely in use and effectiveness. However, these methods are commonly expensive, energy intensive, and many cause unwanted environmentally hazardous byproducts.

Chemical methods widely in use include aeration of contaminated soils, which can take decades to adequately reduce hydrocarbon contamination. Bacterial remediation is also used for solid media contaminated by hydrocarbons, taking years and with common reapplication needs. Thermal means can include thermal desorption followed by combustion of the resulting “smokestream” and subsequent cooling and particle collection. Mechanical means include the use of centrifuges to remove all liquids from solid media, which has mixed results and is usually followed by another subsequent means.

In view of the foregoing, there is a need for improvements in methods and apparatus for increasing the purity of solids, including the removal of chemical contaminants, such as hydrocarbons, from solid materials, such as soils, drilling cuttings and the like.

### SUMMARY OF THE INVENTION

Embodiments of the present invention provide a contaminant removal apparatus comprising a tank; a pump receiving a solid to be purified from the tank; an impact chamber having an impact plate on at least one end thereof; a nozzle receiving the solid to be purified from the pump and directing the solid to be purified toward an impact; a gas additive added to the solid to be purified prior to the solid to be purified being impacted; and a chamber to receive a post impact discharge.

In some embodiments, the impact occurs between the stream of the solid with an impact plate. In some embodiments, the impact occurs between a first stream of the solid with a second stream, which may be of the same or different solid, an air stream, a liquid stream, or the like.

In some embodiments, the gas additive is added prior to the solid to be purified reaching the pump.

In some embodiments, the gas additive is added after the solid to be purified exits the pump and prior to exiting the nozzle.

In some embodiments, the gas additive is in at least one of a liquid, a gas and a solid form when combined with the solid to be purified.

In some embodiments, the gas additive is solid carbon dioxide.

Embodiments of the present invention further provide a method for removing a chemical contaminant from a solid media comprising pumping the solid media from a tank to a pump outlet tube; delivering the solid media, via a nozzle at the end of the pump outlet tube, to contact an impact plate within an impact chamber; injecting a gas additive into the solid media prior to the solid media reaching the impact plate; and collecting a post impact discharge from the solid media after impacting the impact plate.

Embodiments of the present invention also provide a method for removing a chemical contaminant from a solid media comprising pumping the solid media from a tank to a pump outlet tube with a first pump; delivering the solid media, as a first stream via a nozzle at the end of the pump outlet tube, to contact a second stream; injecting a gas additive into the solid media prior to the solid media exiting the nozzle; and collecting a post impact discharge from the solid media after an impact between the first stream and the second stream.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a schematic representation of a stream-to-impact plate apparatus usable to perform methods according to an exemplary embodiment of the present invention;

FIG. 2 illustrates a schematic representation of a stream-to-stream impact apparatus with a single pump and a split stream usable to perform methods according to an exemplary embodiment of the present invention; and

FIG. 3 illustrates a schematic representation of a stream-to-stream impact apparatus with two pumps usable to perform methods according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any method or apparatus, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an apparatus and process to mechanically remove hydrocarbons and other contaminants from solids through high energy slurry impact with a stationary plate or through high energy slurry impact of two or more slurry streams. In addition to the mechanical process, a gas additive, such as CO₂, in solid, liquid or gas form, can be introduced into the slurry stream. The presence of gas additive can aid in the liberation of the contaminant.

Some embodiments of the present invention relate to an apparatus and process for beneficiating ores and removing chemical contaminants from solid materials in an economic and environmentally friendly manner. The apparatus and process mechanically beneficiates ore and removes chemical contaminants by use of positive displacement, progressive cavity, or other types of fluid pumps and high impact collision in a stationary impact chamber. The ore and embedding, or waste, material, or the soil or drilling cuttings, are pumped, typically as a slurry, through a ½-inch to 4-inch nozzle, for example, to collide with a stationary plate in an impact chamber at high velocities or to collide with another stream. The impact partially disassociates these materials. The post impact slurry exiting the impact chamber may be further treated, as desired, by secondary component material separation methods, such as gravity, magnetic, mechanical or the like.

The separation of hydrocarbon or other chemical contaminants from solid media, whether soil, drill cuttings, or other solid media, must overcome both capillary and adhesive forces. The action provided by the apparatus and methods of the present invention is novel and unexpected in a pressure and release scenario as is created by the processes of the present invention. Rapid pressure release through high velocity impact provides adequate applied energy to overcome these forces that retain the chemical contaminants in the solid media.

The process of the present invention for the removal of chemical contaminants can be used with varying input slurry rates, solid particle sizes, and nozzle sizes to optimize the contaminant removal. Temperature variations could increase component separation. The stationary impact plate, as described below, and box could be optimized per input material such as by modifying the impact angle, impact plate design, or distance of the impact plate from the nozzle. Secondary contaminant and media separation, after the high energy aqueous impact, can vary by input material. Variation in control and measurement of each item listed above can modify the process improvement and optimization. Chemicals modifying the contact angle of contaminants within the aqueous solution may alter porous material saturation characteristics and thereby contaminant adhesion forces and attributes.

As used herein, the term “solid media” will refer to soil, drilling cuttings, or other solid materials from which hydrocarbon and/or other chemical contaminants are contained therein and are removed by the apparatus and process of the present invention.

As used herein, the term “gas additive” can include any compound or element that is gaseous at room temperature. Typically, the gas additive will be inert to the solids, liquids and any additives used in the process. Exemplary gas additives include carbon dioxide (CO₂), nitrogen (N₂), argon (Ar), helium (He) and the like. The gas additive may be used in various forms, including gas, liquid or solid. For example, dry ice (solid CO₂), liquid nitrogen, or the like, may be used as the gas additive

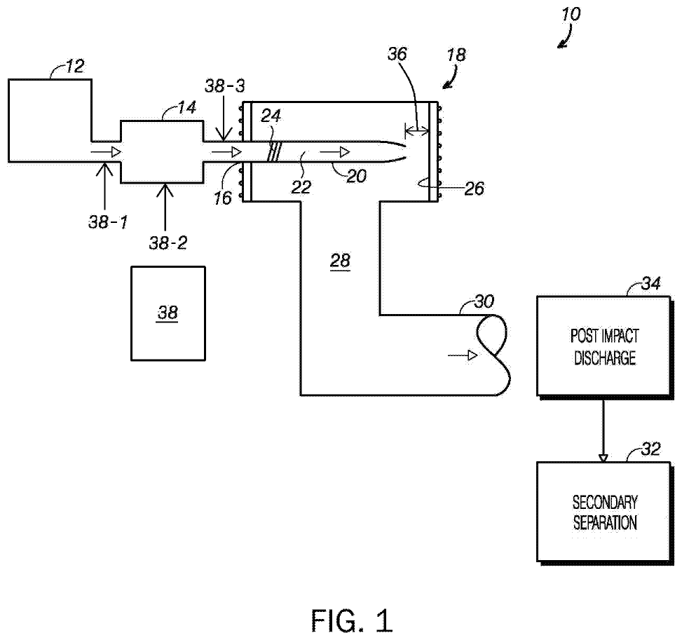

Referring now to FIG. 1, an apparatus 10, also referred to as a beneficiation apparatus 10, or a chemical contaminant removal apparatus 10, can receive a slurry mix of ore or of solid media into a slurry tank 12. This slurry mix may be pumped, via one or more slurry pumps 14 into an impact chamber 18 and can exit, via a nozzle 20 to strike an impact plate 26. The impacted slurry 34 may exit through an opening 28 in the bottom of the impact chamber 18 and a channel 28 may be located beneath the opening 28 to allow the resulting impacted slurry 34, also referred to as post impact slurry discharge 34, to optionally flow to a secondary separation phase 32, which can include, for example, gravity, chemical or magnetic separation. In some embodiments, the impacted slurry 34 may be re-introduced into the slurry tank 12 for further impact on the impact plate 26. The specifics of the secondary separation phase 32 may be based on both the ore sought and the gangue, also known as the embedding, or host, materials as well as the chemical contaminants in the solid media. Thermal, chemical, or further mechanical means of separation may also be utilized at the secondary separation phase 32.

A gas additive 38 may be inserted into the process at various locations in the apparatus. For example, the gas additive 38 may be added at a first location 38-1, which may be before the slurry pump 14, including within the slurry tank 12 or between the slurry tank 12 and the slurry pump 14. The gas additive 38 may be added at a second location 38-2, which may be directly into the slurry pump 14. Further, the gas additive 38 may be added at a third location 38-3, which may be positioned downstream the slurry pump 14, including within the nozzle 20 or between the nozzle 20 and the slurry pump 14. The gas additive 38 may be added in various manners as known in the art. For example, dry ice may be added into the slurry at the slurry tank 12 and processed along with the slurry, including its impact with the impact plate 26.

The nozzle 20 may have a threaded region 22 that may mate with a threaded region 24 on the output tube 16 from the slurry pump 14. Threaded region 22 may be, for example, a female threaded region and threaded region 24 may be a male threaded region, however, the threads may be reversed within the scope of the present invention. The threaded regions 22, 24 allow the user to easily change the nozzle 20 to a desired diameter and distance 36 away from the impact plate 26, depending on the input ore or solid media, the desired output ore or the desired chemical contamination concentration reduction, input slurry rate, liquid concentration in the slurry, pump rate, and the like.

In some embodiments, the nozzle 20 may be formed from a 2-inch pipe that narrows to 1.5 inches at its end. The impact chamber 18 may be formed from a 6-inch pipe with the impact plate 26 disposed at a closed end thereof. The end of the nozzle 20 may be disposed a distance 36 from about 1 inch to about 6 inches, typically from about 2 inches to about 4 inches, from the impact plate 26. Of course, the sizes of each component (such as the nozzle 20 and the impact chamber 18) and the distance between the nozzle 20 and the impact plate 26 may vary depending on the particular application.

The process, according to embodiments of the present invention, may be used with varying input slurry rates and nozzle sizes to optimize the material separation and subsequent ore beneficiation or solid media chemical contamination removal. The concentration of the gas additive may be adjusted to optimize the process and maximize the contamination removal, for example. Temperature variations could increase component material brittleness differentiation. The stationary impact place and impact chamber could be optimized per input material such as by modifying the impact angle, impact plate design or distance of the impact plate from the nozzle. Further, multiple nozzles and/or multiple slurry pumps may be used to direct multiple slurry streams at one or more locations on the impact plate.

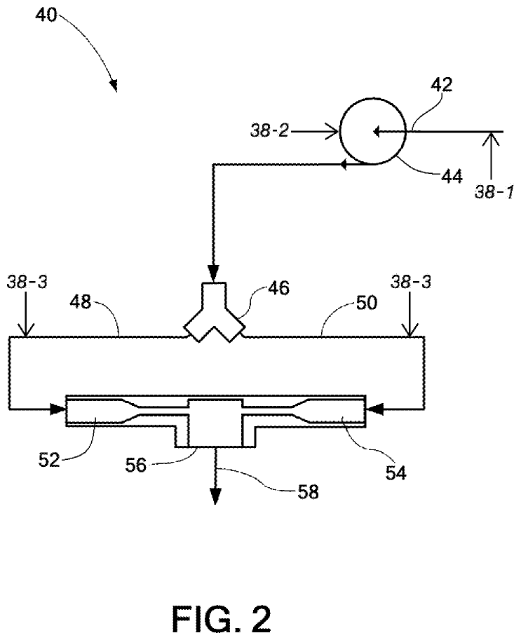

Referring now to FIG. 2, in some embodiments, the slurry may be impacted by directing two or more streams of the slurry at each other. An apparatus 40 can include a pump 44 to direct an input fluid 42, such as a slurry as used in apparatus 10, for example, to a splitter 46 that directs the pumped fluid into feed lines 48, 50. The feed lines 48, 50 direct the pumped fluid into nozzles 52, 54, respectively. The nozzles 52, 54 are directed at each other to cause pressurized fluid from the feed lines 48, 50 to impact each other in an impact chamber 56. The output 58 may be treated, by chemical or gravity separation, for example, depending on the needs and requirements of the user.

Similar to that described above with respect to FIG. 1, a gas additive 38 may be inserted into the process at various locations in the apparatus. For example, the gas additive 38 may be added at a first location 38-1, which may be before the pump 44, including within the slurry tank (not shown) or between the slurry tank and the pump 44. The gas additive 38 may be added at a second location 38-2, which may be directly into the pump 44. Further, the gas additive 38 may be added at a third location 38-3, which may be positioned downstream the pump 44, including within one or more of the nozzles 52, 54 or between the nozzles 52, 54 and the pump 44. While the third location 38-3 is shown downstream the splitter 46 in both of the feed lines 48, 50, the gas additive may be inserted at either or both locations. The gas additive 38 may be added in various manners as known in the art. For example, dry ice may be added into the slurry at the slurry tank and processed along with the slurry, including its stream-to-steam impact.

While the figure shows the nozzles 52, 54 aiming their output streams directly at each other, in some embodiments the output streams of the nozzles 52, 54 may be angled, either horizontally, vertically, or both horizontally and vertically, provided that at least a portion of one nozzle output stream impacts another. Further, while only two nozzles are shown, more than two nozzles may be used, provided that at least a portion of one nozzle output stream impacts another. In other embodiments, two or more nozzles may direct their output streams at each other, while one or more additional nozzles may direct their output at a fixed plate, similar to that described above with respect to FIG. 1.

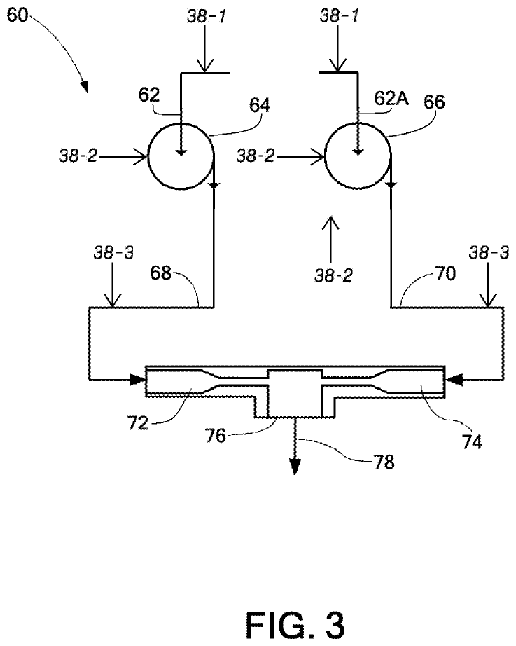

Referring now to FIG. 3, in some embodiments, the slurry may be impacted by directing two or more streams of the slurry at each other. An apparatus 60 can include two or more pumps 44, 46 (two are shown in FIG. 3) to direct an input fluid 62, 62A, such as a contaminated slurry, to feed lines 68, 70. The feed lines 68, 70 direct the pumped fluid into nozzles 72, 74, respectively. The nozzles 72, 74 are directed at each other to cause pressurized fluid from the feed lines 68, 70 to impact each other in an impact chamber 76. The output 78 may be treated, by chemical or gravity separation, for example, depending on the needs and requirements of the user. The embodiment of FIG. 3 may be used when the input fluids 62, 62A are the same or different. In some embodiments, one pump 64 may be removed and pressurized air may be used as the input fluid 62.

Similar to that described above with respect to FIG. 1, a gas additive 38 may be inserted into the process at various locations in the apparatus. For example, the gas additive 38 may be added at a first location 38-1, which may be before the pumps 44, 46, including within the slurry tank (not shown) or between the slurry tank and the pumps 44, 46. The gas additive 38 may be added at a second location 38-2, which may be directly into one or both of the pumps 44, 46. Further, the gas additive 38 may be added at a third location 38-3, which may be positioned downstream the pumps 44, 46, including within one or more of the nozzles 72, 74 or between the nozzles 72, 74 and the pumps 44, 46. While the third location 38-3 is shown downstream both pumps 44, 46, the gas additive may be inserted at either or both locations. The gas additive 38 may be added in various manners as known in the art. For example, dry ice may be added into the slurry at the slurry tank and processed along with the slurry, including its stream-to-steam impact.

While the figure shows the nozzles 72, 74 aiming their output streams directly at each other, in some embodiments the output streams of the nozzles 72, 74 may be angled, either horizontally, vertically, or both horizontally and vertically, provided that at least a portion of one nozzle output stream impacts another. Further, while only two nozzles are shown, more than two nozzles may be used, provided that at least a portion of one nozzle output stream impacts another. In other embodiments, two or more nozzles may direct their output streams at each other, while one or more additional nozzles may direct their output at a fixed plate, similar to that described above with respect to FIG. 1.

While the above refers to pumping a slurry for impact with a plate or with another slurry, an air stream or the like, it should be understood that the solids may be pumped dry, without the addition of an additional liquid, such as water. When formed as a slurry, the concentration of the solids in the liquid may vary, depending on the specific application.

### EXAMPLES

### Hydrocarbon Remediation with CO₂ Example 1—Drill Cuttings

Roughly 5 gallons of oil contaminated drilling cuttings from a horizontal well drilled with invert mud (diesel based mud) was tested and found to have 84,400 ppm Diesel range Organics (DRO). This material was mixed with roughly 100 gallons of water to form a slurry of roughly 5% solids. Roughly 1 bls of dry ice was added to the slurry just prior to it being pumped through a 1″ nozzle at a flow rate of 500 gpm (31.5 l/s) and a pressure of 85 psig (586 kPa) for one pass. A sample was collected and tested for DRO and found to have 37,400 ppm. The subsequent mix was again enhanced with another pound of dry ice and processed again through the apparatus at similar rates and pressures and a subsequent sample was collected and tested for DRO and found to have 14,500 ppm.

### Hydrocarbon Remediation with CO₂ Example 2—Drill Cuttings

Roughly 5 gallons of oil contaminated drilling cuttings from a horizontal well drilled with invert mud (diesel based mud) was tested and found to have 84,400 ppm Diesel range Organics (DRO). This material was mixed with roughly 100 gallons of water to form a slurry of roughly 5% solids, which was pumped through a 1″ nozzle at a flow rate of 500 gpm (31.5 l/s) and a pressure of 85 psig (586 kPa) for five passes. A sample was collected and tested for DRO and found to have 9,260 ppm. The subsequent mix was enhanced with a pound of dry ice and processed again through the apparatus at similar rates and pressures and a subsequent sample was collected and tested for DRO and found to have 3,650 ppm.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A contaminant or gangue removal apparatus comprising:
a tank;
a pump receiving a solid to be purified from the tank;
an impact chamber having an impact plate on at least one end thereof;
a nozzle receiving the solid to be purified from the pump and directing the solid to be purified toward an impact;
a gas additive added to the solid to be purified prior to the solid to be purified being impacted; and
a chamber to receive a post impact discharge.

2. The apparatus of claim 1, further comprising an impact plate, where the impact occurs when the solid to be purified strikes the impact plate.

3. The apparatus of claim 1, further comprising at least a second stream directed at a first stream after exiting the nozzle, where the impact occurs when the second stream meets the first stream.

4. The apparatus of claim 3, wherein the second stream includes a second stream of the solid to be purified.

5. The apparatus of claim 1, wherein the solid to be purified includes at least one of an ore slurry and a contaminated solid media.

6. The apparatus of claim 1, wherein the nozzle is removably attached to an output pipe from the slurry pump.

7. The apparatus of claim 1, wherein the gas additive is added prior to the solid to be purified reaching the pump.

8. The apparatus of claim 1, wherein the gas additive is added after the solid to be purified exits the pump and prior to exiting the nozzle.

9. The apparatus of claim 1, wherein the gas additive is in at least one of a liquid, a gas and a solid form when combined with the solid to be purified.

10. The apparatus of claim 1, wherein the gas additive is solid carbon dioxide.

11. A method for removing a chemical contaminant from a solid media comprising:
pumping the solid media from a tank to a pump outlet tube;
delivering the solid media, via a nozzle at the end of the pump outlet tube, to contact an impact plate within an impact chamber;
injecting a gas additive into the solid media prior to the solid media reaching the impact plate; and
collecting a post impact discharge from the solid media after impacting the impact plate.

12. The method of claim 11, wherein the solid media is pumped as a slurry.

13. The method of claim 11, further comprising adding the gas additive prior to the solid media reaching the pump.

14. The method of claim 11, further comprising adding the gas additive after the solid media exits the pump and prior to exiting the nozzle.

15. The method of claim 11, wherein the gas additive is in at least one of a liquid, a gas and a solid form when combined with the solid media.

16. The method of claim 11, wherein the gas additive is solid carbon dioxide.

17. A method for removing a chemical contaminant from a solid media comprising:
pumping the solid media from a tank to a pump outlet tube with a first pump;
delivering the solid media, as a first stream via a nozzle at the end of the pump outlet tube, to contact a second stream;
injecting a gas additive into the solid media prior to the solid media exiting the nozzle; and
collecting a post impact discharge from the solid media after an impact between the first stream and the second stream.

18. The method of claim 17, wherein the second stream is formed of the solid media.

19. The method of claim 17, further comprising pumping the solid media from the tank to a second pump outlet tube with a second pump.

20. The method of claim 17, wherein the gas additive is in at least one of a liquid, a gas and a solid form when combined with the solid media.
